(19) United States
(12) Patent Application Publication
(10) Pub. No.: US 2024/0406637 A1
(43) Pub. Date: Dec. 5, 2024

(54) ELECTROACOUSTIC TRANSDUCER

(71) Applicant: Audio-Technica Corporation, Tokyo (JP)

(72) Inventors: Hiromichi OZAWA, Tokyo (JP); Nonomi FUKUSHIMA (SHIWAKU), Tokyo (JP)

(21) Appl. No.: 18/799,279

(22) Filed: Aug. 9, 2024

Related U.S. Application Data
(63) Continuation of application No. PCT/JP2023/000375, filed on Jan. 11, 2023.

(30) Foreign Application Priority Data
Apr. 28, 2022 (JP) 2022-074284

(51) Int. Cl. H04R 9/02; H04R 7/12; H04R 9/04

(52) U.S. Cl. CPC H04R 9/025; H04R 7/127; H04R 9/045; H04R 2209/021

(57) ABSTRACT

This electroacoustic transducer has a diaphragm and a magnetic circuit part. The magnetic circuit part includes a permanent magnet, a pole piece that is magnetically connected to one surface of the permanent magnet in the thickness direction, and a yoke body that includes a bottom portion, and a peripheral wall portion and that is magnetically connected to the other surface of the permanent magnet in the thickness direction on the bottom portion. At least one of the pole piece and the bottom portion of the yoke body is a laminate in which a plurality of magnetic metal plates are stacked in the thickness direction of the permanent magnet with electrical insulation between each plate.

### CROSS-REFERENCE TO RELATED APPLICATIONS

The present application is a continuation application of International Application number PCT/JP2023/375, filed on Jan. 11, 2023, which claims priority under 35 U.S.C. § 119(a) to Japanese Patent Application No. 2022-074284, filed on Apr. 28, 2022. The contents of these applications are incorporated herein by reference in their entirety.

### BACKGROUND OF THE INVENTION

The present disclosure relates to an electroacoustic transducer.

Conventionally, an electroacoustic transducer of a headphone unit is provided with a magnetic circuit part as a component that forms a magnetic gap that is a space in which a voice coil vibrates (for example, see Japanese Unexamined Patent Application Publication No. 2017-92704). The magnetic circuit part includes a permanent magnet, a yoke on which the permanent magnet is disposed, and a pole piece disposed so as to cover the permanent magnet, and constitutes a magnetic closed loop circuit. A member constituting the magnetic circuit part such as a yoke and a pole piece is electromagnetic soft iron, for example. A member having a sufficient thickness is used for a yoke and a pole piece in order to secure a driving force for driving a diaphragm.

A loss of driving force occurs in a member constituting a magnetic circuit part such as a yoke and a pole piece due to an influence of an eddy current generated in the member during operation of an electroacoustic transducer. In particular, an influence on reproduced sound due to a loss of driving force cannot be ignored in a magnetic circuit having a relatively small driving force such as an electroacoustic transducer for headphones. Therefore, there is a need for improvement in a conventional electroacoustic transducer to enhance quality of reproduced sound.

### BRIEF SUMMARY OF THE INVENTION

The present disclosure focuses on this point, and an object thereof is to provide an electroacoustic transducer capable of reducing a loss of driving force due to an influence of an eddy current in a magnetic circuit part to enhance sound quality.

An aspect of the present disclosure provides an electroacoustic transducer including a diaphragm to which a voice coil is connected, and a magnetic circuit part that forms a magnetic gap which is a space in which the voice coil vibrates, wherein the magnetic circuit part includes a permanent magnet that is magnetized in a thickness direction, a pole piece that is magnetically connected to one surface of the permanent magnet in the thickness direction, and a yoke body that includes i) a bottom surface part on which the permanent magnet is disposed and ii) a peripheral wall part extending from a peripheral edge of the bottom surface part in a direction away from the bottom surface part, with the bottom surface part being magnetically connected to the other surface of the permanent magnet in the thickness direction, and at least any of the pole piece or the bottom surface part of the yoke body is a stacked component in which a plurality of magnetic metal plates electrically insulated from each other are stacked in the thickness direction of the permanent magnet.

### BRIEF DESCRIPTION OF THE DRAWINGS

FIG. 1 is a cross-sectional view of a configuration of an electroacoustic transducer according to a first embodiment.

FIG. 2 is a cross-sectional view of a magnetic circuit part of the electroacoustic transducer.

FIG. 3 is a perspective view of an appearance of a magnetic circuit unit.

FIG. 4 is a schematic view illustrating an eddy current generated in a stacked component.

FIG. 5 is a cross-sectional view illustrating a configuration of an electroacoustic transducer according to a second embodiment.

FIG. 6 is a cross-sectional view showing parts of a yoke body of the electroacoustic transducer of FIG. 5 in a separated manner.

FIG. 7 is a cross-sectional view showing a configuration of a modification of the second embodiment.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### First Embodiment

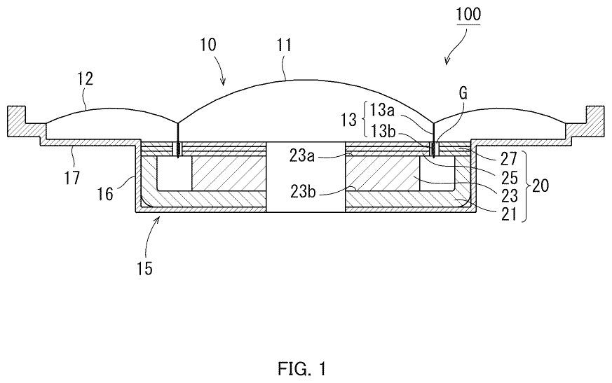

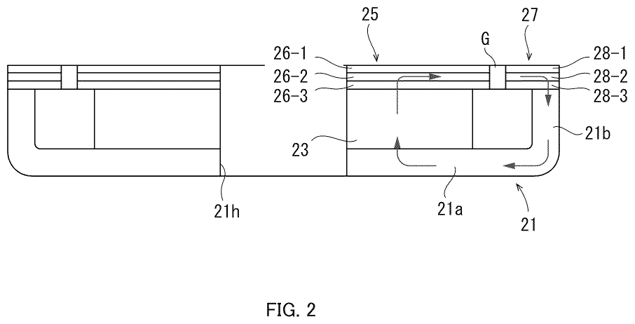

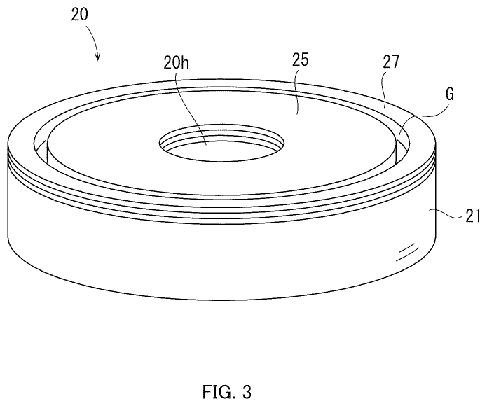

An electroacoustic transducer 100 according to an embodiment of the present disclosure will be described while referring to drawings. FIG. 1 is a cross-sectional view of a configuration of the electroacoustic transducer 100 according to a first embodiment. FIG. 2 is a cross-sectional view of a magnetic circuit part 20 of the electroacoustic transducer 100. FIG. 3 is a perspective view of an appearance of the magnetic circuit part 20. In the following, terms indicating directions such as “upper,” “lower,” “right,” and “left” are used according to an orientation of an object depicted in the drawings, but these terms are not used to limit the present disclosure. The orientations of “upper” and “lower” correspond to a thickness direction of the electroacoustic transducer 100.

The electroacoustic transducer 100 is a dynamic electroacoustic transducer including a diaphragm 10, a unit holder 15, and the magnetic circuit part 20. The electroacoustic transducer 100 is used as a part of a headphone or a speaker, for example.

One of the characteristics of the electroacoustic transducer 100 of the present embodiment is that at least a part of the magnetic circuit part 20 is composed of stacked components that are each a plurality of magnetic metal plates, in order to reduce a loss of driving force due to an eddy current generated in the magnetic circuit part 20. In the first embodiment, an example in which a pole piece 25 and a ring yoke 27 constituting the magnetic circuit part 20 are stacked components will be described. It should be noted that, in the electroacoustic transducer 100, constituent elements other than the magnetic circuit part 20 may have conventionally known configurations. Each unit will be described below.

### (Diaphragm 10)

The diaphragm 10 is a vibrator that generates sound waves by vibrating the surrounding air through its own vibrations. The diaphragm 10 includes a center dome 11, a sub dome 12, and a voice coil part 13.

The center dome 11 is a dome-shaped portion and is located near the center of the electroacoustic transducer 100. The sub dome 12 is a portion also referred to as an edge, and is located around the periphery of the center dome 11. The sub dome 12 is provided integrally with the center dome 11, and an outer peripheral portion of the sub dome 12 is securely attached to the unit holder 15.

The voice coil part 13 is a member connected to a back surface (surface at a lower portion in FIG. 1) of the diaphragm 10. The voice coil part 13 includes a circular tube-shaped support 13a and a voice coil 13b securely attached to the support 13a. The voice coil 13b is located in a magnetic gap G, and generates driving force for vibrating the diaphragm 10 when a current flows through the voice coil 13b.

The unit holder 15 is a member to which the magnetic circuit part 20 and the diaphragm 10 are attached. The unit holder 15 is made of resin, for example, and includes a unit holding part 16 and a flange part 17. The unit holding part 16 is a cup-shaped portion having a circular contour, for example, and the magnetic circuit part 20 is disposed therein. The flange part 17 is a portion formed around the periphery of the unit holding part 16, and extends radially outward from an upper end portion of the unit holding part 16.

### (Regarding Magnetic Circuit Part 20)

As shown in FIGS. 1 to 3, the magnetic circuit part 20 includes a yoke body 21, a permanent magnet 23, a pole piece 25, and a ring yoke 27. The magnetic circuit part 20 forms the magnetic gap G which is a space in which the voice coil part 13 vibrates. In the present embodiment, a configuration in which a through-hole 20h (see FIG. 3) is formed in the center portion of the magnetic circuit part 20 is exemplified, but the present disclosure is not limited to such a configuration.

The yoke body 21 is a cup-shaped magnetic member that forms a space for accommodating the permanent magnet 23. Specifically, the yoke body 21 has a circular contour shape. As shown in FIG. 2, the yoke body 21 has a bottom surface part 21a and a peripheral wall part 21b.

The bottom surface part 21a has a disk shape, and has an opening part 21h formed in the center portion in this example. The permanent magnet 23 is disposed on the bottom surface part 21a. The peripheral wall part 21b extends from a peripheral edge of the bottom surface part 21a in a direction away from the bottom surface part 21a (upward in the drawings). Specifically, the peripheral wall part 21b extends perpendicularly to the bottom surface part 21a. The ring yoke 27 is disposed at an upper end portion of the peripheral wall part 21b.

The permanent magnet 23 is disposed on the bottom surface part 21a and the ring yoke 27 is disposed on the upper end portion of the peripheral wall part 21b in this manner. Thus, the yoke body 21 is magnetically connected to the permanent magnet 23, and is magnetically connected to the ring yoke 27.

The permanent magnet 23 has a circular tube shape, as an example, and is magnetized in a thickness direction. Specifically, the permanent magnet 23 is magnetized so that a portion close to the diaphragm 10 is the N pole and an opposite portion is the S pole, for example. The permanent magnet 23 includes a flat upper surface 23a and a flat lower surface 23b (see FIG. 1). The upper surface 23a corresponds to one surface of the permanent magnet in the thickness direction in the present disclosure, and the lower surface 23b corresponds to the other surface of the permanent magnet in the thickness direction. It should be noted that the permanent magnet may have a cylindrical shape in the present disclosure.

The pole piece 25 is a magnetic material disposed on the upper surface 23a of the permanent magnet 23. The pole piece 25 has a disc-like shape with an open center. The ring yoke 27 is also a magnetic material and is disposed around the periphery of the pole piece 25 to form the magnetic gap G with the pole piece 25.

With the magnetic circuit part 20 having the above-described structure, a magnetic closed loop circuit is formed in the magnetic circuit part 20 by the permanent magnet 23, the yoke body 21, the ring yoke 27, the pole piece 25, and the magnetic gap G, as shown in FIG. 2. In this circuit, a magnetic field is generated in a direction indicated by arrows in FIG. 2.

### (Stacked Structures of Pole Piece 25 and Ring Yoke 27)

In the present embodiment, each of the pole piece 25 and the ring yoke 27 is configured as a stacked component formed of a plurality of magnetic metal plates, instead of as a single plate material. An example in which each of the pole piece 25 and the ring yoke 27 is formed of three magnetic metal plates will be described in the following. In the present disclosure, the number of magnetic metal plates may be two or four or more.

As shown in FIGS. 2 and 3, the pole piece 25 includes a first magnetic metal plate 26-1, a second magnetic metal plate 26-2, and a third magnetic metal plate 26-3 (hereinafter, also simply referred to as “magnetic metal plates 26”). In the present embodiment, all three of the magnetic metal plates 26 have the same shape. The magnetic metal plate 26 is a circular thin plate, and has a circular opening formed in the center thereof. In this example, the magnetic metal plate 26 has a diameter larger than a diameter of the permanent magnet 23.

The material of the magnetic metal plate 26 is preferably a high magnetic flux density soft magnetic material having high saturation magnetic flux density and magnetic permeability. Specifically, the magnetic metal plate 26 is an alloy of iron and cobalt, for example. More specifically, the material of the magnetic metal plate 26 is permendur, for example. The thickness of the magnetic metal plate 26 is greater than or equal to 0.1 and less than or equal to 1 mm, for example. As a specific example, the pole piece 25 of the present embodiment has a structure in which three magnetic metal plates 26 having thicknesses of 0.4 mm are stacked.

The plurality of magnetic metal plates 26 are stacked in a state where adjacent magnetic metal plates 26 are electrically insulated from each other. The magnetic metal plates 26 are bonded to each other with an insulating adhesive, for example, and the magnetic metal plates 26 are electrically insulated from each other by the adhesive. An anaerobic adhesive is used as the adhesive, for example. When the pole piece 25 is manufactured, for example, three magnetic metal plates 26 stacked in a state where the adhesive is applied between the adjacent magnetic metal plates 26 are pressed in the thickness direction, and the adhesive is cured. Thus, the pole piece 25 which is a stacked component is manufactured.

The pole piece 25 is disposed on the upper surface 23a of the permanent magnet 23. The pole piece 25 may be disposed directly on the upper surface 23a or may be disposed with another member (not shown in figures) interposed therebetween, as long as the pole piece 25 is disposed in such a manner as to be magnetically connected to the permanent magnet 23.

The ring yoke 27 is also a stacked component made of a plurality of magnetic metal plates, like the pole piece 25. In the present embodiment, the ring yoke 27 includes a first magnetic metal plate 28-1, a second magnetic metal plate 28-2, and a third magnetic metal plate 28-3 (hereinafter, also simply referred to as “magnetic metal plates 28”). In the present embodiment, the number of layers of magnetic metal plates 26 constituting the pole piece 25 and the number of layers of magnetic metal plates 28 constituting the ring yoke 27 are the same, for example. The magnetic metal plate 28 has an annular shape having a diameter larger than that of the magnetic metal plate 26 of the pole piece 25.

The material and the thickness of the magnetic metal plate 28 are the same as those of the magnetic metal plate 26 of the pole piece 25, for example. If the material and the thickness of the magnetic metal plate 28 are the same as those of the magnetic metal plate 26 of the pole piece 25 as described above, there is an advantage in that the magnetic metal plate 26 and the magnetic metal plate 28 can be manufactured from one steel plate with high yield.

Like the magnetic metal plates 26 of the pole piece 25, the plurality of magnetic metal plates 28 are stacked through press processing using, for example, an anaerobic adhesive. Thus, the ring yoke 27, which is a stacked component, is manufactured. The thickness of the pole piece 25 and the thickness of the ring yoke 27 are the same, for example.

The example in which the magnetic metal plates are electrically insulated from each other by the adhesive was described above, but the present disclosure is not limited to such a configuration. For example, the magnetic metal plates may be electrically insulated from each other by an insulating coating formed on a surface of the magnetic metal plate.

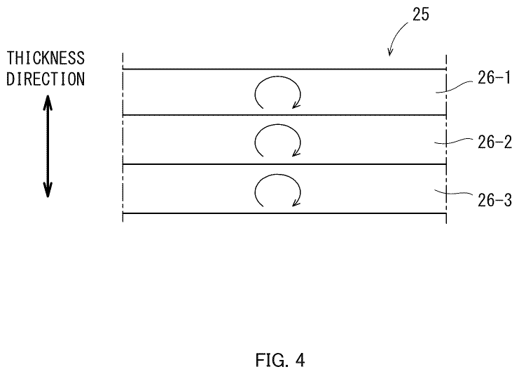

FIG. 4 is a schematic view illustrating an eddy current generated in the stacked component. FIG. 4 shows a part of a cross section of the pole piece 25 as an example of the stacked component. In a case of the configuration of the present embodiment, the eddy current generated in the cross section of each magnetic metal plate 26 of the pole piece 25 is reduced as compared with a case where the pole piece 25 is formed of a single member. If the pole piece 25 is a single member having a thickness substantially equal to the thickness of the three magnetic metal plates 26 shown in FIG. 4, for example, the eddy current flowing through the inside of the member is large, and the loss of driving force increases accordingly. In contrast, according to the configuration of the present embodiment, the eddy current generated in the cross section of the magnetic metal plate 26 is reduced, and thus the loss of driving force is reduced.

It is not shown in figures, but the eddy current is also reduced in the ring yoke 27 configured as a stacked component, and thus the loss of driving force is reduced by the same principle as that of the pole piece 25 described above.

### Effect

As described above, according to the electroacoustic transducer 100 of the present embodiment, the pole piece 25 and the ring yoke 27 are configured as stacked components, and so the eddy currents generated in these members during operation of the electroacoustic transducer 100 are reduced, and the loss of driving force can be reduced. As a result, the sound quality of the electroacoustic transducer 100 is enhanced. It should be noted that the electroacoustic transducer according to the embodiment of the present disclosure includes the ring yoke 27, but the electroacoustic transducer according to an embodiment of the present disclosure may include only the pole piece 25 as a stacked component without including the ring yoke 27.

### Second Embodiment

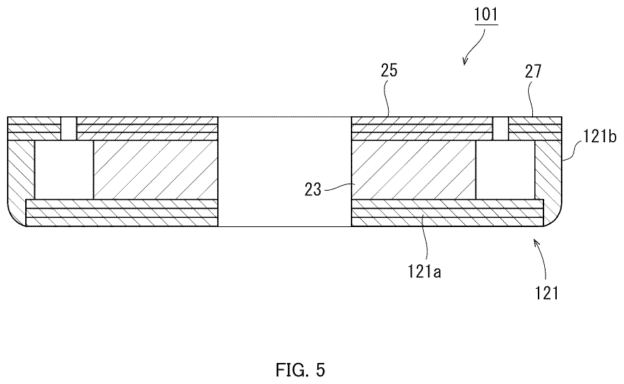

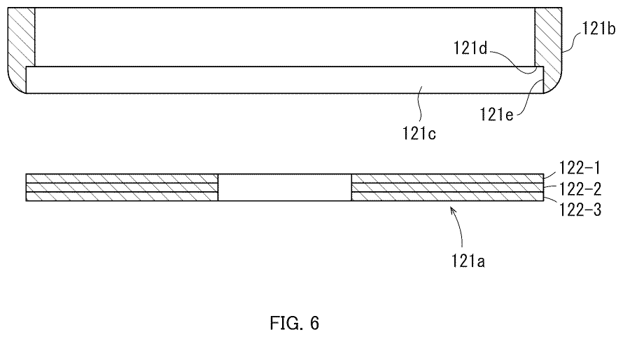

FIG. 5 is a cross-sectional view illustrating a configuration of an electroacoustic transducer 101 according to a second embodiment. FIG. 6 is a cross-sectional view showing parts of a yoke body 121 of the electroacoustic transducer 101 of FIG. 5 in a separated manner. In the electroacoustic transducer 101 of FIG. 5, a configuration of the yoke body 121 is different from that of the yoke body 21 of the first embodiment. Other configurations are the same as those of the first embodiment, so a common explanation will be omitted.

The yoke body 121 of the electroacoustic transducer 101 has a bottom surface part 121a and a peripheral wall part 121b. As an example, the shape of the yoke body 121 is the same as that of the yoke body 21 of the first embodiment.

Like the pole piece 25 and the ring yoke 27, the bottom surface part 121a is a stacked component in which a plurality of magnetic metal plates are stacked. The material of the magnetic metal plate of the bottom surface part 121a is the same as the material of the pole piece 25 and the ring yoke 27, for example. Specifically, as shown in FIG. 6, the bottom surface part 121a has a first magnetic metal plate 122-1, a second magnetic metal plate 122-2, and a third magnetic metal plate 122-3 (hereinafter, simply referred to as “magnetic metal plates 122”). The magnetic metal plate 122 is formed to have a diameter larger than the diameter of the permanent magnet 23. In the present embodiment, the diameter of the magnetic metal plate 122 is larger than the diameter of the pole piece 25 and smaller than the diameter of the ring yoke 27. It is not shown in figures, but in an embodiment of the present disclosure, the diameter of the magnetic metal plate 122 may be the same as the diameter of the pole piece 25, or may be the same as the diameter of the ring yoke 27.

The three magnetic metal plates 122 are stacked through press processing using an anaerobic adhesive, like the magnetic metal plates of the pole piece 25 and the ring yoke 27, for example. The bottom surface part 121a, which is a stacked component made of the three magnetic metal plates 122, is fitted into a concave part 121c formed in the peripheral wall part 121b.

The concave part 121c is a concave portion having a circular contour shape to which the bottom surface part 121a is securely attached, and has a receiving surface 121d and an inner peripheral surface 121e. The receiving surface 121d is a surface that receives one surface (upper surface in the drawings) of the stacked component of the bottom surface part 121a. The receiving surface 121d is a plane perpendicular to the thickness direction of the yoke body 121, for example. The inner peripheral surface 121e is an inner surface of a circular tube and has an inner diameter slightly larger than the diameter of the bottom surface part 121a. The inner peripheral surface 121e supports an outer peripheral surface of the bottom surface part 121a in a state where the bottom surface part 121a is disposed in the concave part 121c, thereby defining the position of the bottom surface part 121a. A depth of the concave part 121c is the same as the thickness of the stacked component of the bottom surface part 121a, for example.

In the electroacoustic transducer 101 of the second embodiment configured as described above, the bottom surface part 121a, which is a part of the yoke body 121, is also configured as a stacked component in which a plurality of magnetic metal plates are stacked. Therefore, as compared with the configuration of the first embodiment, the eddy current is further reduced, and the loss of driving force can be reduced.

The bottom surface part 121a does not have to be entirely configured as a stacked component, and only a part thereof needs to be configured as a stacked component. However, according to the configuration in which the bottom surface part 121a is entirely configured as a stacked component and the bottom surface part 121a is disposed in the concave part 121c of the peripheral wall part 121b as in the present embodiment, the structure of the bottom surface part 121a does not become more complicated and the bottom surface part 121a and the peripheral wall part 121b can be securely attached with high positional accuracy.

It should be noted that the number of the magnetic metal plates 122 in the bottom surface part 121a can be appropriately changed. The thickness of the bottom surface part 121a is not necessarily the same as those of the pole piece 25 and the ring yoke 27.

### Modification

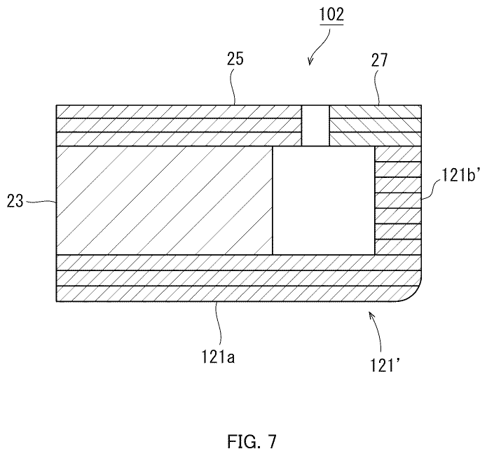

FIG. 7 is a cross-sectional view showing a configuration of a modification of the second embodiment. In an electroacoustic transducer 102 of FIG. 7, a yoke body 121′ includes the bottom surface part 121a and a peripheral wall part 121b′, and both the bottom surface part 121a and the peripheral wall part 121b′ are provided as stacked components in which a plurality of magnetic metal plates electrically insulated from each other are stacked.

The bottom surface part 121a is basically the same as in the configurations shown in FIGS. 5 and 6, but in the configuration of FIG. 7, the diameter of the bottom surface part 121a is slightly larger than those of the configurations of FIGS. 5 and 6. The peripheral wall part 121b′ includes a structure in which a plurality of annular magnetic metal plates are stacked in the thickness direction of the permanent magnet 23. The magnetic metal plates of the peripheral wall part 121b′ are securely attached to each other with an anaerobic adhesive, as in the above-described embodiment, for example.

As described above, the peripheral wall part 121b′ is also formed of a stacked component in which magnetic metal plates are stacked, and thus the eddy current is further reduced and the loss of driving force can be reduced as compared with the configuration of the above-described embodiment.

It should be noted that a specific configuration of the present disclosure has been described above by referring the drawings, but in the present disclosure, it is not necessary that all the members of the pole piece, the ring yoke, and the yoke body are configured as a stacked component. In the present disclosure, it is sufficient if at least one of the pole piece, the ring yoke, or the yoke body is composed of a stacked component in which a plurality of magnetic metal plates electrically insulated from each other are stacked in the thickness direction of the permanent magnet.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. An electroacoustic transducer comprising:
a diaphragm to which a voice coil is connected; and
a magnetic circuit part that forms a magnetic gap which is a space in which the voice coil vibrates, wherein
the magnetic circuit part includes:
a permanent magnet that is magnetized in a thickness direction,
a pole piece that is magnetically connected to one surface of the permanent magnet in the thickness direction, and
a yoke body that includes i) a bottom surface part on which the permanent magnet is disposed and ii) a peripheral wall part extending from a peripheral edge of the bottom surface part in a direction away from the bottom surface part, with the bottom surface part being magnetically connected to the other surface of the permanent magnet in the thickness direction, and
at least any of the pole piece or the bottom surface part of the yoke body is a stacked component in which a plurality of magnetic metal plates electrically insulated from each other are stacked in the thickness direction of the permanent magnet.

2. The electroacoustic transducer according to claim 1, further comprising:
a ring yoke that is disposed around the periphery of the pole piece, is magnetically connected to the yoke body, and forms the magnetic gap with the pole piece, wherein
the ring yoke is a stacked component in which a plurality of magnetic metal plates electrically insulated from each other are stacked in a thickness direction of the permanent magnet.

3. The electroacoustic transducer according to claim 1, wherein
a concave part to which the stacked component of the bottom surface part is securely attached is formed in the peripheral wall part, and
the concave part includes:
a receiving surface for receiving one surface of the stacked component of the bottom surface part, and
an inner peripheral surface for supporting an outer peripheral surface of the stacked component of the bottom surface part.

4. The electroacoustic transducer according to claim 3, wherein
a depth of the concave part is the same as the thickness of the bottom surface part.

5. The electroacoustic transducer according to claim 1, wherein
both the bottom surface part and the peripheral wall part are stacked components in which a plurality of the magnetic metal plates electrically insulated from each other are stacked, and
the plurality of the magnetic metal plates are stacked in the thickness direction of the permanent magnet, in the peripheral wall part.

6. The electroacoustic transducer according to claim 1, wherein
the magnetic metal plates of the stacked component are electrically insulated from each other by bonding adjacent magnetic metal plates with an adhesive.

7. The electroacoustic transducer according to claim 1, wherein
the permanent magnet has a cylindrical shape or a circular tube shape,
the pole piece is a stacked component in which a plurality of the magnetic metal plates having circular shapes are stacked,
the bottom surface part of the yoke body is also a stacked component in which a plurality of the magnetic metal plates having circular shapes are stacked, and
the stacked component of the pole piece and the stacked component of the bottom surface part of the yoke body are both formed to have a diameter larger than a diameter of the permanent magnet.

8. The electroacoustic transducer of claim 2, wherein
the number of layers of the magnetic metal plates constituting the pole piece and the number of layers of the magnetic metal plates constituting the ring yoke are the same, and a thickness of each magnetic metal plate of the pole piece and a thickness of each magnetic metal plate of the ring yoke are the same.
